(19) United States
(12) Patent Application Publication
(10) Pub. No.: US 2023/0281617 A1
(43) Pub. Date: Sep. 7, 2023

(54) METHOD AND SYSTEM OF TRANSACTION DISPUTE RESOLUTION

(71) Applicant: MASTERCARD INTERNATIONAL INCORPORATED, Purchase, NY (US)

(72) Inventors: Oskar DURIS, Walnut Creek, CA (US); Jamal KHAN, Ridgefield, NJ (US); Sasyasri GEEDIPALLI, Rye Brook, NY (US); Biser Mitkov DIMITROV, New York, NY (US); Sébastien LE CALLONNEC, Greystones (IE)

(73) Assignee: MASTERCARD INTERNATIONAL INCORPORATED, Purchase, NY (US)

(21) Appl. No.: 17/685,762

(22) Filed: Mar. 3, 2022

(51) Int. Cl. G06Q 20/38; G06Q 20/36

(52) U.S. Cl. CPC G06Q 20/389; G06Q 20/36

(57) ABSTRACT

A smart contract is received for a new blockchain transaction and added to a blockchain. The smart contract includes information on a merchant blockchain wallet, a reserve blockchain wallet for the merchant, a dispute blockchain wallet, and a time period. During the time period, when a dispute is lodged by the consumer, the smart contract causes a new transaction to be added to the blockchain that transfers an amount to cover the disputed transaction from the merchant's reserve wallet to the dispute wallet. The dispute is resolved and the dispute resolution added to the blockchain, which causes the smart contract to add another new transaction to the blockchain that either transfers the amount from the dispute wallet back to the merchant's wallet or from the dispute wallet back to the consumer's wallet.

### FIELD

The present disclosure relates to transaction dispute resolution, specifically dispute resolution for a blockchain transaction that utilizes multiple blockchain wallets and a smart contract.

### BACKGROUND

Blockchain was initially created as a storage mechanism for use in conducting payment transactions with a cryptographic currency. Using a blockchain provides a number of benefits, such as decentralization, distributed computing, transparency regarding transactions, and yet also providing anonymity as to the individuals or entities involved in a transaction. One of the more popular aspects of a blockchain is that it is an immutable record: every transaction ever that is part of the chain is stored therein and cannot be changed due to the computational requirements and bandwidth limitations, particularly as a chain gets longer and a blockchain network adds more nodes.

However, because a blockchain is immutable, there is no built-in way to reverse a transaction, such as if a transaction is dispute or even if a consumer is interested in making a return for a purchase. Instead, the recourse for the parties involved is a new transaction where the initial recipient transfers back the original amount of currency to the initial sending party. In cases where both parties are in agreement for the return or refund, such a transaction can be added to the blockchain without issue. On the other hand, if there is a dispute, the initial sending party has no ability to force a return of currency or other resolution to the dispute. Thus, there is a need for an improvement to existing blockchain systems to enable a dispute resolution process for a blockchain transaction.

### SUMMARY

The present disclosure provides a description of systems and methods for facilitating dispute resolution for a blockchain transaction using a smart contract. A smart contract is received for a new blockchain transaction and added to a blockchain. The smart contract includes information on a merchant blockchain wallet, a reserve blockchain wallet for the merchant, a dispute blockchain wallet, and a time period. During the time period, when a dispute is lodged by the consumer, the smart contract causes a new transaction to be added to the blockchain that transfers an amount to cover the disputed transaction from the merchant's reserve wallet to the dispute wallet. The dispute is resolved and the dispute resolution added to the blockchain, which causes the smart contract to add another new transaction to the blockchain that either transfers the amount from the dispute wallet back to the merchant's wallet or from the dispute wallet back to the consumer's wallet. The result is a dispute resolution process that utilizes existing blockchain technology while ensuring that a consumer can dispute a blockchain transaction and successfully receive refunded currency without adversely affecting a merchant's ability to transact.

A method for facilitating dispute resolution for a blockchain transaction using a smart contract includes: receiving, by a receiver of a blockchain node in a blockchain network, a smart contract, wherein the smart contract includes data associated with a first blockchain wallet, data associated with a second blockchain wallet, data associated with a third blockchain wallet, and a period of time; receiving, by the receiver of the blockchain node, a first blockchain transaction for payment of a digital currency amount from a fourth blockchain wallet to the first blockchain wallet; adding, by a processor of the blockchain node, the smart contract and the first blockchain transaction to a blockchain associated with the blockchain network in one or more first new blocks; receiving, by the receiver of the blockchain node, a dispute notification, wherein the dispute notification identifies one of the first blockchain transaction and the smart contract; adding, by the processor of the blockchain node, a second blockchain transaction to the blockchain in a second new block, wherein the second blockchain transaction is for payment of the digital currency amount from the second blockchain wallet to the third blockchain wallet; receiving, by the receiver of the blockchain node, a dispute resolution, wherein the dispute resolution indicates a decision for a first party or a second party; and adding, by the processor of the blockchain node, a third blockchain transaction to the blockchain in a third new block, wherein the third blockchain transaction is for payment of the digital currency amount (i) from the third blockchain wallet to the fourth blockchain wallet if the dispute resolution indicates a decision for the first party, or (ii) from the third blockchain wallet to the first blockchain wallet if the dispute resolution indicates a decision for the second party.

A system for facilitating dispute resolution for a blockchain transaction using a smart contract includes: a blockchain network including a plurality of blockchain nodes; and a blockchain node included in the blockchain network, wherein the blockchain node includes a receiver receiving a smart contract, wherein the smart contract includes data associated with a first blockchain wallet, data associated with a second blockchain wallet, data associated with a third blockchain wallet, and a period of time, and receiving a first blockchain transaction for payment of a digital currency amount from a fourth blockchain wallet to the first blockchain wallet, and a processor adding the smart contract and the first blockchain transaction to a blockchain associated with the blockchain network in one or more first new blocks, the receiver of the blockchain node further receives a dispute notification, wherein the dispute notification identifies one of the first blockchain transaction and the smart contract, the processor of the blockchain node further adds a second blockchain transaction to the blockchain in a second new block, wherein the second blockchain transaction is for payment of the digital currency amount from the second blockchain wallet to the third blockchain wallet, the receiver of the blockchain node further receives a dispute resolution, wherein the dispute resolution indicates a decision for a first party or a second party, and the processor of the blockchain node further adds a third blockchain transaction to the blockchain in a third new block, wherein the third blockchain transaction is for payment of the digital currency amount (i) from the third blockchain wallet to the fourth blockchain wallet if the dispute resolution indicates a decision for the first party, or (ii) from the third blockchain wallet to the first blockchain wallet if the dispute resolution indicates a decision for the second party.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for facilitating dispute resolution for a blockchain transaction in accordance with exemplary embodiments.

FIG. 2 is a block diagram illustrating a blockchain node for facilitating dispute resolution for a blockchain transaction in the system of FIG. 1 in accordance with exemplary embodiments.

FIG. 3 is a flow diagram illustrating a process for facilitating dispute resolution for a blockchain transaction by the blockchain node in the system of FIG. 1 in accordance with exemplary embodiments.

FIG. 4 is a flow chart illustrating an exemplary method for facilitating dispute resolution for a blockchain transaction in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### System for Facilitating Dispute Resolution for Blockchain Transactions

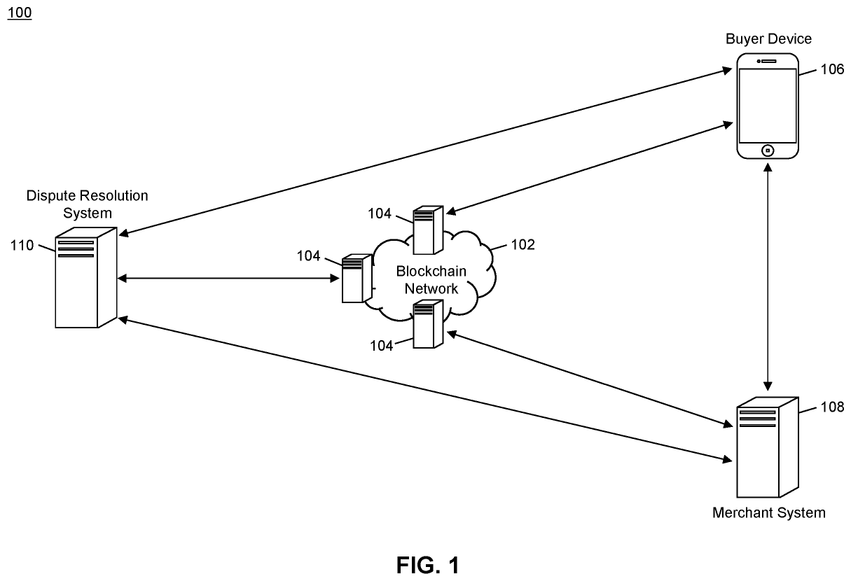

FIG. 1 illustrates a system 100 that facilitates a dispute resolution process for a blockchain transaction through the use of a smart contract.

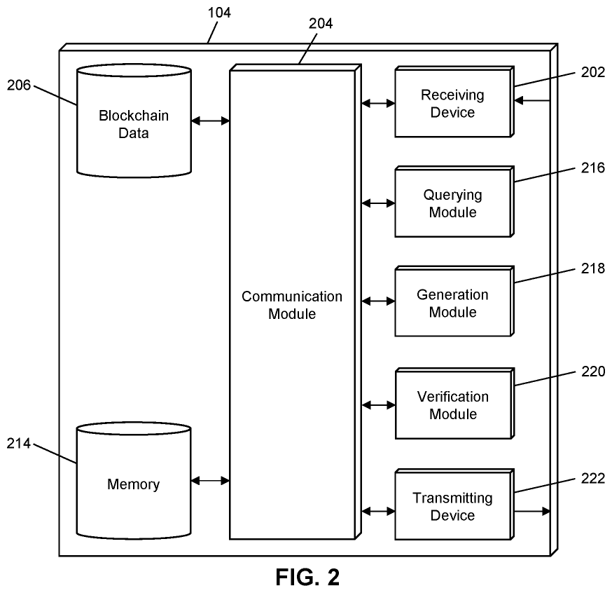

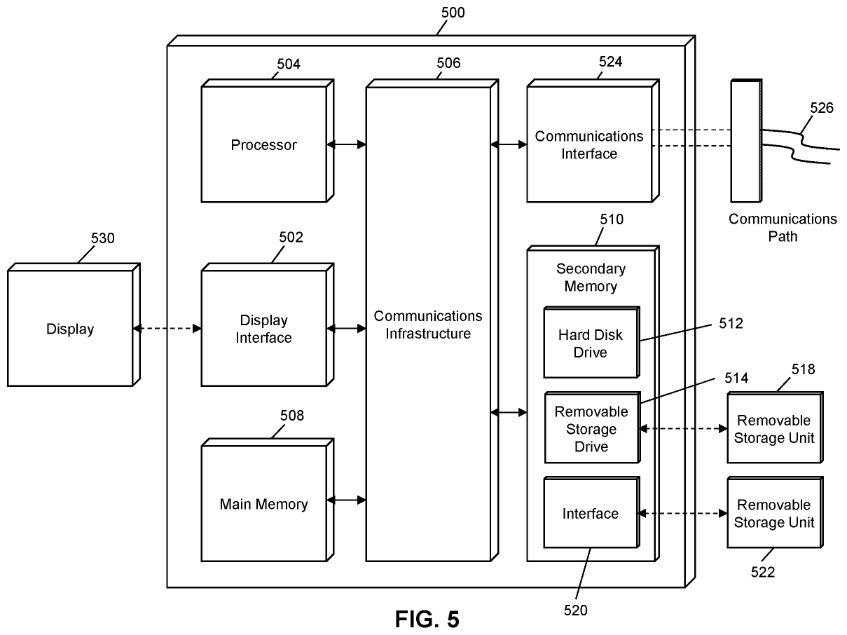

The system 100 can include a blockchain network 102. The blockchain network 102 can be comprised of a plurality of blockchain nodes 104. Each blockchain node 104 can be a computing system, such as illustrated in FIG. 2 or 5, discussed in more detail below, that is configured to perform functions related to the processing and management of the blockchain, including the generation of blockchain data values, verification of proposed blockchain transactions, verification of digital signatures, generation of new blocks, validation of new blocks, and maintenance of a copy of the blockchain.

The blockchain can be a distributed ledger that is comprised of at least a plurality of blocks. Each block can include at least a block header and one or more data values. Each block header can include at least a timestamp, a block reference value, and a data reference value. The timestamp can be a time at which the block header was generated, and can be represented using any suitable method (e.g., UNIX timestamp, DateTime, etc.). The block reference value can be a value that references an earlier block (e.g., based on timestamp) in the blockchain. In some embodiments, a block reference value in a block header can be a reference to the block header of the most recently added block prior to the respective block. In an exemplary embodiment, the block reference value can be a hash value generated via the hashing of the block header of the most recently added block. The data reference value can similarly be a reference to the one or more data values stored in the block that includes the block header. In an exemplary embodiment, the data reference value can be a hash value generated via the hashing of the one or more data values. For instance, the block reference value can be the root of a Merkle tree generated using the one or more data values.

The use of the block reference value and data reference value in each block header can result in the blockchain being immutable. Any attempted modification to a data value would require the generation of a new data reference value for that block, which would thereby require the subsequent block's block reference value to be newly generated, further requiring the generation of a new block reference value in every subsequent block. This would have to be performed and updated in every blockchain node 104 in the blockchain network 102 prior to the generation and addition of a new block to the blockchain in order for the change to be made permanent. Computational and communication limitations can make such a modification exceedingly difficult, if not impossible, thus rendering the blockchain immutable.

In some embodiments, the blockchain can be used to store information regarding blockchain transactions conducted between two different blockchain wallets. A blockchain wallet can include a private key of a cryptographic key pair that is used to generate digital signatures that serve as authorization by a payer for a blockchain transaction, where the digital signature can be verified by the blockchain network 108 using the public key of the cryptographic key pair. In some cases, the term “blockchain wallet” can refer specifically to the private key. In other cases, the term “blockchain wallet” can refer to a computing device (e.g., buyer device 106, merchant system 108, etc.) that stores the private key for use thereof in blockchain transactions. For instance, each computing device can each have their own private key for respective cryptographic key pairs, and can each be a blockchain wallet for use in transactions with the blockchain associated with the blockchain network. Computing devices can be any type of device suitable to store and utilize a blockchain wallet, such as a desktop computer, laptop computer, notebook computer, tablet computer, cellular phone, smart phone, smart watch, smart television, wearable computing device, implantable computing device, etc.

Each blockchain data value stored in the blockchain can correspond to a blockchain transaction or other storage of data, as applicable. A blockchain transaction can consist of at least: a digital signature of the sender of currency (e.g., a buyer device 106) that is generated using the sender's private key, a blockchain address of the recipient of currency (e.g., a merchant system 108) generated using the recipient's public key, and a blockchain currency amount that is transferred or other data being stored. In some blockchain transactions, the transaction can also include one or more blockchain addresses of the sender where blockchain currency is currently stored (e.g., where the digital signature proves their access to such currency), as well as an address generated using the sender's public key for any change that is to be retained by the sender. Addresses to which cryptographic currency has been sent that can be used in future transactions are referred to as “output” addresses, as each address was previously used to capture output of a prior blockchain transaction, also referred to as “unspent transactions,” due to there being currency sent to the address in a prior transaction where that currency is still unspent. In some cases, a blockchain transaction can also include the sender's public key, for use by an entity in validating the transaction. For the traditional processing of a blockchain transaction, such data can be provided to a blockchain node 104 in the blockchain network 102, either by the sender or the recipient. The node can verify the digital signature using the public key in the cryptographic key pair of the sender's wallet and also verify the sender's access to the funds (e.g., that the unspent transactions have not yet been spent and were sent to address associated with the sender's wallet), a process known as “confirmation” of a transaction, and then include the blockchain transaction in a new block. The new block can be validated by other nodes in the blockchain network 102 before being added to the blockchain and distributed to all of the blockchain nodes 104 in the blockchain network 102, respectively, in traditional blockchain implementations. In cases where a blockchain data value cannot be related to a blockchain transaction, but instead the storage of other types of data, blockchain data values can still include or otherwise involve the validation of a digital signature.

In the system 100, the blockchain can be configured to store smart contracts. A smart contract can be a self-executable data object that is stored on the blockchain in a blockchain data value that executes once one or more criteria have been satisfied. The smart contract can monitor new blocks added to the blockchain until expected data is added to the blockchain that fulfills criteria or criteria is satisfied in another manner. Once the criteria is satisfied, the smart contract can self-execute and perform one or more actions related to the blockchain as a result, such as the submission of a new transaction for the transfer of digital currency or the submission of new data for storage in a new blockchain data value in the blockchain.

In an example, users of two different computing devices can make a deal for the sale of a vehicle that is to be paid for using digital currency. The buyer can agree to pay a specific amount of digital currency, such as 500 units, that is to be paid upon delivery of the vehicle by the seller. In a traditional situation, the seller must give the vehicle to the buyer in the hope that the buyer will fulfill their end of the bargain with difficult recourse if the buyer does not satisfy payment. With smart contracts, a smart contract can be developed that will self-execute to add a new transaction to the blockchain for transfer of the 500 units of currency from the buyer's blockchain wallet to the seller's blockchain wallet. The criteria for the smart contract can be storage of a deed of transfer or other document on the blockchain. When the smart contract detects the document added to the blockchain, it can self-execute and the seller is paid by the buyer. Using the smart contract, the buyer cannot prevent the transfer of currency if the seller fulfills the transfer. Likewise, the seller cannot force the transfer of currency without actually providing the buyer with documented ownership of the vehicle. The smart contract can also be developed such that, if storage of the document is not detected before a predetermined period of time, the smart contract expires, such as to ensure that the seller fulfills transfer of the vehicle in a timely fashion else the buyer retains control of their digital currency.

In the system 100, a buyer device 106 and a merchant system 108 participate in a blockchain transaction. The buyer device 106 and merchant system 108 can be any type of computing device suitable for performing the functions discussed herein, such as a laptop computer, desktop computer, notebook computer, tablet computer, cellular phone, smart phone, smart watch, smart television, wearable computing device, etc. A consumer associated with the buyer device 106 purchases one of more products from a merchant associated with the merchant system 108, where the consumer uses digital currency of the blockchain associated with the blockchain network 102 to make the purchase. To perform the transaction, the buyer device 106 or merchant system 108 submits the new blockchain transaction to a blockchain node 104 in the blockchain network 102 that includes one or more unspent transaction outputs sent to the blockchain wallet of the buyer device 106, a digital signature generated using the buyer device's private key, a transaction amount, and a destination address for the blockchain wallet of the merchant system 108 using the merchant system's public key. The blockchain node 104 receives the blockchain transaction, confirms the transaction, and includes the transaction in a new block that is confirmed by other blockchain nodes 104 in the blockchain network 102 and added to the blockchain.

In order for a dispute resolution process to be available for the blockchain transaction, the merchant system 108 can submit a smart contract to a blockchain node 104 in the blockchain network 102 or data for inclusion in a smart contract to the blockchain node 104, where the blockchain node 104 itself can generate the smart contract. The smart contract can include data for at least three different blockchain wallets: a blockchain wallet for the merchant system 108 used to receive and transfer digital currency, referred to herein as a “merchant blockchain wallet,” a blockchain wallet that holds digital currency in reserve to satisfy disputed transactions, referred to herein as a “reserve blockchain wallet,” and a blockchain wallet used to hold digital currency that is the subject of a disputed transaction, referred to herein as a “dispute blockchain wallet.” Data included for each blockchain wallet can include one or more destination addresses generated by public keys of the respective blockchain wallet and/or the public keys themselves, one or more digital signatures generated using the private keys of the respective blockchain wallets, unspent transaction outputs, digital currency amounts associated therewith, etc. The smart contract can also include a period of time or an expiration date and/or time.

In some embodiments, the merchant system 108 may have control or possession of the merchant blockchain wallet and reserve blockchain wallet. In such embodiments, a blockchain node 104 or dispute resolution system 110 can have control or possession of the dispute blockchain wallet, where the blockchain node 104 or dispute resolution system 110 can possess or have access to the private key of the blockchain wallet. In some cases, the system 100 can include one or more exchange systems, which can be used to store private keys for blockchain wallets on behalf of other entities. In such cases, functions performed by one of the entities of the system 100 as discussed herein can be performed by the associated exchange system, as applicable.

The smart contract can be transmitted to the blockchain node 104 or generated thereby and added to the blockchain in a new blockchain data value that is included in a new block that is confirmed and added to the blockchain. In some cases, the merchant system 108 may transmit the smart contract or data for use in the generation thereof prior to transmission and addition of the blockchain transaction for the initial payment of digital currency from the buyer to the merchant. In such cases, the smart contract can be added to the blockchain, and the buyer device 106 can use the smart contract to identify the merchant blockchain wallet to where digital currency is to be sent based on the data included therein. The buyer device 106 can then generate the blockchain transaction and submit the transaction to a blockchain node 104 for inclusion in the blockchain.

After the blockchain transaction and smart contract have both been added to the blockchain, the buyer can be interested in disputing the transaction. The buyer device 106 can electronically transmit a data message to a dispute resolution system 110 to initiate a dispute resolution process for the blockchain transaction. The data message can include data identifying the disputed blockchain transaction, such as a transaction identifier, blockchain address, or other unique data included in the blockchain transaction or its blockchain data entry. The data message can also include additional information, such as a reason for the dispute and data in support of the reason. For example, the buyer can dispute the blockchain transaction due to defective merchandise and can provide evidence of the defect.

The dispute resolution system 110 can receive the data message and initiate a dispute resolution process to determine if the dispute should be ruled in favor of the buyer, and the appropriate amount of digital currency returned to the buyer, or the merchant, where the merchant can retain the transferred digital currency. The dispute resolution system 110 can submit a notification message to a blockchain node 104 in the blockchain network 102 to notify the blockchain node 104 of the initiated dispute. In some embodiments, the buyer device 106 can submit the dispute data message to the blockchain node 104, where the blockchain node 104 can forward the data message to the dispute resolution system 110.

Once the blockchain node 104 has been informed of the dispute, a new blockchain transaction can be added to the blockchain. The new blockchain transaction can be for payment of an amount of digital currency that is equal to the amount of digital currency in the disputed transaction and be made from the reserve blockchain wallet to the dispute blockchain wallet. In some cases, the amount for the new blockchain transaction can be greater than the amount of the disputed transaction, such as to include fees, such as may be collected by the dispute resolution system 110 for performing the dispute resolution process. In some embodiments, the blockchain node 104 can add the dispute notification message to the blockchain in a new blockchain data value that is included in a new block that is added to the blockchain. In some cases, the blockchain node 104 can generate the new blockchain transaction using the data included in the smart contract upon receipt of the dispute notification message. In other cases, the smart contract may self-execute upon detecting the dispute notification message being added to the blockchain, which can result in submission of the new blockchain transaction to a blockchain node 104 for inclusion in the blockchain.

Once the new blockchain transaction has been added to the blockchain, the digital currency can be held in the dispute blockchain wallet while the dispute resolution process takes place. The dispute resolution system 110 can proceed with resolving the dispute using traditional methods and systems, such as by collecting evidence from the buyer device 106 and merchant system 108, reviewing any transaction agreements, analyzing other provided data, etc. The dispute resolution system 110 can determine a resolution, or result, of the dispute as a part of the process. In some instances, the dispute resolution system 110 can utilize multiple mediators or arbitrators to determine a result for a dispute. In some such instances, the number of mediators or arbitrators can be based on the amount of digital currency being disputed. Once the result has been determined, the dispute resolution system 110 can electronically transmit notification messages to the buyer device 106 and/or merchant system 108 to inform the participants of the resolution of the dispute, which can include a reason for the dispute, any incurred fees, etc. As part of the resolution, the dispute resolution system 110 can also electronically transmit a result message for the dispute to a blockchain node 104 in the blockchain network 102.

The blockchain node 104 can receive the dispute result message and can add a new blockchain transaction to the blockchain. The new blockchain transaction can be for payment of the digital currency amount of the disputed blockchain transaction and/or second blockchain transaction and be made from the dispute blockchain wallet to either a blockchain wallet of the buyer device 106 (e.g., identified as the payer of the disputed blockchain transaction) if the result is in favor of the buyer, or to the merchant blockchain wallet if the result is in favor of the merchant system 108. In an exemplary embodiment, the dispute result message can be added to the blockchain in a new blockchain data entry included in a new block confirmed and added to the blockchain. In some cases, the blockchain node 104 itself can generate the new blockchain transaction following receipt of the dispute result message. In other cases, the smart contract can detect addition of the dispute result message on the blockchain and, as a result, can self-execute, which can result in submission of the new blockchain transaction to a blockchain node 104 for inclusion in the blockchain.

In some instances, the dispute resolution system 110 can collect a fee for performing the dispute resolution process. In such instances, the last blockchain transaction that is added to the blockchain can include a transfer of digital currency from the dispute blockchain wallet to a blockchain wallet associated with the dispute resolution system 110. In such cases, the fees can be paid by the buyer device 106 or merchant system 108. In some instances, the dispute resolution system 110 can determine which entity is responsible for the fees, such as based on terms in the smart contract, the result of the dispute process, etc.

In embodiments where the smart contract includes a period of time or expiration date, the buyer device 106 can be required to submit a dispute for the associated blockchain transaction prior to expiration of the period of time. In such embodiments, the smart contract may fail to self-execute to submit new blockchain transactions for part of a dispute resolution process if the period of time has expired or expiration date passed. In such cases, if the buyer device 106 does not initiate the dispute process prior to expiration of the period of time or expiration date, then the disputed transaction can remain without a dispute resolution process occurring. In some cases, a smart contract can include additional criteria, such as additional fees to be incurred if the transaction is disputed. For instance, a merchant can charge a restocking fee for a disputed transaction where a refund as a result of the dispute resolution process can be for the original digital currency amount minus the specified fee.

In some cases, the merchant system 108 can be required to fund the reserve blockchain wallet with a suitable amount of digital currency to cover the digital currency amounts of blockchain transactions for which the period of time or expiration date has not yet expired. In such cases, a smart contract can be verified by the blockchain node 104 prior to addition to the blockchain, where the blockchain node 104 can verify the reserve blockchain wallet to ensure that the reserve blockchain wallet has sufficient access to digital currency that covers all pending smart contracts. In some cases, the initial blockchain transaction can be made from the buyer's blockchain wallet direct to the reserve blockchain wallet, where the merchant can keep the digital currency in the reserve blockchain wallet until the period of time or expiration date for dispute expires. In some such cases, the smart contract can be configured to self-execute after the expiration to transfer the digital currency from the reserve blockchain wallet to the merchant blockchain wallet.

The methods and systems discussed herein provide for the ability for a participant in a blockchain transaction to dispute the transaction. By utilizing smart contracts and multiple blockchain wallets, a blockchain transaction can be disputed to the satisfaction of either the buyer or merchant without modification to any existing systems. As a result, a blockchain transaction can be disputed on legacy systems through the use of smart contracts and a dispute resolution system 110, providing for a significant improvement over existing systems.

### Blockchain Node

FIG. 2 illustrates an embodiment of a blockchain node 104. It will be apparent to persons having skill in the relevant art that the embodiment of the blockchain node 104 illustrated in FIG. 2 is provided as illustration only and cannot be exhaustive to all possible configurations of the blockchain node 104 suitable for performing the functions as discussed herein. For example, the computer system 500 illustrated in FIG. 5 and discussed in more detail below can be a suitable configuration of the blockchain node 104. In some cases, additional components of the system 100, such as the buyer device 106, merchant system 108, and dispute resolution system 110 can include the components illustrated in FIG. 2 and discussed below.

The blockchain node 104 can include a receiving device 202. The receiving device 202 can be configured to receive data over one or more networks via one or more network protocols. In some instances, the receiving device 202 can be configured to receive data from other blockchain nodes 104, buyer devices 106, merchant systems 108, dispute resolution systems 110, and other systems and entities via one or more communication methods, such as radio frequency, local area networks, wireless area networks, cellular communication networks, Bluetooth, the Internet, etc. In some embodiments, the receiving device 202 can be comprised of multiple devices, such as different receiving devices for receiving data over different networks, such as a first receiving device for receiving data over a local area network and a second receiving device for receiving data via the Internet. The receiving device 202 can receive electronically transmitted data signals, where data can be superimposed or otherwise encoded on the data signal and decoded, parsed, read, or otherwise obtained via receipt of the data signal by the receiving device 202. In some instances, the receiving device 202 can include a parsing module for parsing the received data signal to obtain the data superimposed thereon. For example, the receiving device 202 can include a parser program configured to receive and transform the received data signal into usable input for the functions performed by the processing device to carry out the methods and systems described herein.

The receiving device 202 can be configured to receive data signals electronically transmitted by other blockchain nodes 104 that can be superimposed or otherwise encoded with blocks, blockchain data values, confirmation messages, cryptographic keys, smart contracts, etc. The receiving device 202 can also be configured to receive data signals electronically transmitted by buyer devices 106 and/or merchant systems 108, which can be superimposed or otherwise encoded with new blockchain transactions, new smart contracts, requests for blockchain data, cryptographic keys, digital signatures, unspent transaction outputs, digital currency amounts, blockchain wallet data, etc. The receiving device 202 can be further configured to receive data signals electronically transmitted by dispute resolution systems 110 that can be superimposed or otherwise encoded with dispute notification messages, dispute result messages, etc.

The blockchain node 104 can also include a communication module 204. The communication module 204 can be configured to transmit data between modules, engines, databases, memories, and other components of the blockchain node 104 for use in performing the functions discussed herein. The communication module 204 can be comprised of one or more communication types and utilize various communication methods for communications within a computing device. For example, the communication module 204 can be comprised of a bus, contact pin connectors, wires, etc. In some embodiments, the communication module 204 can also be configured to communicate between internal components of the blockchain node 104 and external components of the blockchain node 104, such as externally connected databases, display devices, input devices, etc. The blockchain node 104 can also include a processing device. The processing device can be configured to perform the functions of the blockchain node 104 discussed herein as will be apparent to persons having skill in the relevant art. In some embodiments, the processing device can include and/or be comprised of a plurality of engines and/or modules specially configured to perform one or more functions of the processing device, such as a querying module 216, generation module 218, verification module 220, etc. As used herein, the term “module” can be software or hardware particularly programmed to receive an input, perform one or more processes using the input, and provides an output. The input, output, and processes performed by various modules will be apparent to one skilled in the art based upon the present disclosure.

The blockchain node 104 can include blockchain data 206. The blockchain data 206 can be configured to store data associated with a blockchain. Blockchain data 206 can include blockchain wallet data, blocks, cryptographic keys, data formatting rules, communication data, smart contract data, pending blockchain transactions, pending smart contracts, etc.

The blockchain node 104 can also include a memory 214. The memory 214 can be configured to store data for use by the blockchain node 104 in performing the functions discussed herein, such as public and private keys, symmetric keys, etc. The memory 214 can be configured to store data using suitable data formatting methods and schema and can be any suitable type of memory, such as read-only memory, random access memory, etc. The memory 214 can include, for example, encryption keys and algorithms, communication protocols and standards, data formatting standards and protocols, program code for modules and application programs of the processing device, and other data that can be suitable for use by the blockchain node 104 in the performance of the functions disclosed herein as will be apparent to persons having skill in the relevant art. In some embodiments, the memory 214 can be comprised of or can otherwise include a relational database that utilizes structured query language for the storage, identification, modifying, updating, accessing, etc. of structured data sets stored therein. The memory 214 can be configured to store, for example, cryptographic keys, cryptographic key pairs, cryptographic algorithms, encryption algorithms, communication information, data formatting rules, signature generation algorithms, smart contract data, etc.

The blockchain node 104 can include a querying module 216. The querying module 216 can be configured to execute queries on databases to identify information. The querying module 216 can receive one or more data values or query strings, and can execute a query string based thereon on an indicated database, such as the memory 214 of the blockchain node 104 to identify information stored therein. The querying module 216 can then output the identified information to an appropriate engine or module of the blockchain node 104 as necessary. The querying module 216 can, for example, execute a query on the blockchain data 206 to identify pending blockchain transactions for inclusion in a new block to be generated by the blockchain node 104.

The blockchain node 104 can also include a generation module 218. The generation module 218 can be configured to generate data for use by the blockchain node 104 in performing the functions discussed herein. The generation module 218 can receive instructions as input, can generate data based on the instructions, and can output the generated data to one or more modules of the blockchain node 104. For example, the generation module 218 can be configured to generate blockchain data entries, blocks, confirmation messages, cryptographic key pairs, digital signatures, functions and instructions for performing actions, etc.

The processing server 102 can also include a verification module 220. The verification module 220 can be configured to perform verifications for the processing server 102 as part of the functions discussed herein. The verification module 220 can receive instructions as input, which can also include data to be used in performing a verification, can perform a verification as requested, and can output a result of the verification to another module or engine of the processing server 102. The verification module 220 can, for example, be configured to verification digital signatures using suitable signature generation algorithms and keys, verify smart contract data, verify new blockchain transactions, etc.

The blockchain node 104 can also include a transmitting device 222. The transmitting device 222 can be configured to transmit data over one or more networks via one or more network protocols. In some instances, the transmitting device 222 can be configured to transmit data to other blockchain nodes 104, buyer devices 106, merchant systems 108, dispute resolution systems 110, and other entities via one or more communication methods, local area networks, wireless area networks, cellular communication, Bluetooth, radio frequency, the Internet, etc. In some embodiments, the transmitting device 222 can be comprised of multiple devices, such as different transmitting devices for transmitting data over different networks, such as a first transmitting device for transmitting data over a local area network and a second transmitting device for transmitting data via the Internet. The transmitting device 222 can electronically transmit data signals that have data superimposed that can be parsed by a receiving computing device. In some instances, the transmitting device 222 can include one or more modules for superimposing, encoding, or otherwise formatting data into data signals suitable for transmission.

The transmitting device 222 can be configured to electronically transmit data signals to other blockchain nodes 104 that can be superimposed or otherwise encoded with blockchain data values, blocks, confirmation messages, requests for blockchain data, smart contract data, etc. The transmitting device 222 can also be configured to electronically transmit data signals to buyer devices 106 and/or merchant systems 108, which can be superimposed or otherwise encoded with blockchain data, blocks, blockchain data values, identifiers for new blockchain transactions, requests for digital signatures or cryptographic keys, etc. The transmitting device 222 can be further configured to electronically transmit data signals to dispute resolution systems 110 that can be superimposed or otherwise encoded with dispute data messages, requests for dispute information, etc.

### Process for Facilitating Dispute Resolution of a Blockchain Transaction

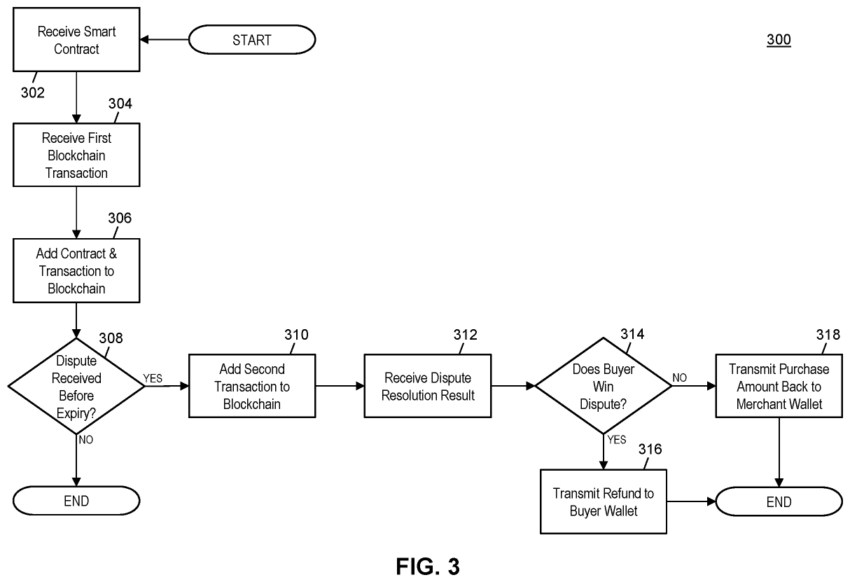

FIG. 3 illustrates a process 300 for facilitating dispute resolution of a blockchain transaction as executed by the blockchain node 104 of the system 100 of FIG. 1 and of FIG. 2.

In step 302, the receiving device 202 of the blockchain node 104 can receive a smart contract or data associated therewith from a merchant system 108 that is associated with a new blockchain transaction to be submitted. The smart contract can include data for a merchant blockchain wallet and reserve blockchain wallet and a period of time. The data received from the merchant system 108 can also include data for a dispute blockchain wallet, or data for the dispute blockchain wallet can be added to the received data by the blockchain node 104. In some cases, the data can be included in an already generated smart contract, or the generation module 218 of the blockchain node 104 can generate the smart contract using the received data.

In step 304, the receiving device 204 of the blockchain node 104 can receive a first blockchain transaction from the buyer device 106. The first blockchain transaction can be for a digital currency amount to be paid from the buyer's blockchain wallet to the merchant blockchain wallet. In step 306, the generation module 218 of the blockchain node 104 can generate blockchain data entries for the first blockchain transaction and the smart contract and generate a new block that includes the at least newly generated blockchain data entries. The new block can be distributed to other blockchain nodes 104 in the blockchain network 102 by the transmitting device 222 of the blockchain node 104 for confirmation and addition to the blockchain.

In step 308, the blockchain node 104 can determine if a dispute for the first blockchain transaction has been received by the receiving device 202 of the blockchain node 104 prior to expiration of the period of time in the smart contract. If a dispute has not been lodged, then the process 300 can be completed and the first blockchain transaction can stand. If a dispute has been received before expiration of the period of time, then, in step 310, the blockchain node 104 can add a second transaction to the blockchain. The second transaction can be made for payment of at least the digital currency amount from the disputed transaction from the reserve blockchain wallet to the dispute blockchain wallet. In some cases, the second blockchain transaction can be generated by the generation module 218 of the blockchain node 104. In other cases, the blockchain node 104 can add a dispute message to the blockchain where the second blockchain transaction can be generated via self-execution of the smart contract upon detection of the dispute message.

In step 312, the receiving device 202 of the blockchain node 104 can receive a result message for the dispute from the dispute resolution system 110. In some embodiments, the generation module 218 for the blockchain node 104 can generate a new blockchain data value that includes the result message that is included in a new block that is added to the blockchain. In step 314, the blockchain node 104 can determine if the buyer wins the dispute or if the merchant wins the dispute based on the content of the result message. If the buyer wins the dispute then, in step 316, a third blockchain transaction is added to the blockchain that refunds the digital currency amount from the dispute blockchain transaction to the blockchain wallet of the buyer device 106. If the merchant wins the dispute then, in step 318, a third blockchain transaction is added to the blockchain that transfers the digital currency amount from the dispute blockchain wallet back to the merchant blockchain wallet. In some cases, the generation module 218 of the blockchain node 104 generates the third blockchain transaction using data from the first blockchain transaction and smart contract. In other cases, the third blockchain transaction can be generated by execution of the smart contract upon detection of the addition of the dispute result to the blockchain.

### Exemplary Method for Facilitating Dispute Resolution of a Blockchain Transaction

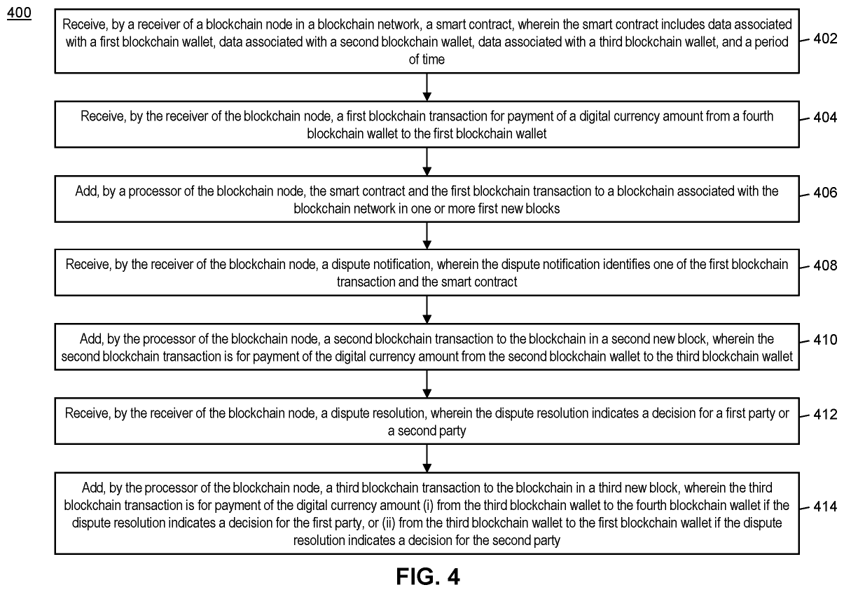

FIG. 4 illustrates a method 400 for facilitating dispute resolution of a blockchain transaction through the use of a smart contract and multiple blockchain wallets.

In step 402, a smart contract can be received by a receiver (e.g., receiving device 202) of a blockchain node (e.g., blockchain node 104) in a blockchain network (e.g., blockchain network 102), wherein the smart contract includes data associated with a first blockchain wallet, data associated with a second blockchain wallet, data associated with a third blockchain wallet, and a period of time. In step 404, a first blockchain transaction for payment of a digital currency amount from a fourth blockchain wallet to the first blockchain wallet can be received by the receiver of the blockchain node. In step 406, the smart contract and the first blockchain transaction can be added, by a process of the blockchain node, to a blockchain associated with the blockchain network in one or more first new blocks. In step 408, a dispute notification can be received by the receiver of the blockchain node, wherein the dispute notification identifies one of the first blockchain transaction and the smart contract.

In step 410, a second blockchain transaction can be added to the blockchain by the processor of the blockchain node in a second new block, wherein the second blockchain transaction is for payment of the digital currency amount from the second blockchain wallet to the third blockchain wallet. In step 412, a dispute resolution can be received by the receiver of the blockchain node, wherein the dispute resolution indicates a decision for a first party or a second party. In step 414, a third blockchain transaction can be added by the processor of the blockchain node to the blockchain in a third new block, wherein the third blockchain transaction is for payment of the digital currency amount (i) from the third blockchain wallet to the fourth blockchain wallet if the dispute resolution indicates a decision for the first party, or (ii) from the third blockchain wallet to the first blockchain wallet if the dispute resolution indicates a decision for the second party.

In one embodiment, the third blockchain transaction can be further for payment of an additional currency amount to a fifth blockchain wallet. In a further embodiment, the fifth blockchain wallet can be associated with a dispute resolution entity (e.g., dispute resolution system 110), and the dispute resolution can be received from the dispute resolution entity. In some embodiments, the smart contract can further include an identification value, and the first blockchain transaction can include the identification value.

In one embodiment, the method 400 can further include adding, by the processor of the blockchain node, the dispute resolution to the blockchain in a fourth new block prior to adding the third blockchain transaction to the blockchain. In a further embodiment, the smart contract can self-execute upon detection of the fourth new block including the dispute resolution, and the receiver of the blockchain node can receive, from self-execution of the smart contract, the third blockchain transaction. In some embodiments, the method 400 can also include adding, by the processor of the blockchain node, the dispute notification to the blockchain in a fourth new block prior to adding the second blockchain transaction to the blockchain. In one embodiment, the dispute notification can be received prior to expiration of the period of time.

### Computer System Architecture

FIG. 5 illustrates a computer system 500 in which embodiments of the present disclosure, or portions thereof, can be implemented as computer-readable code. For example, the blockchain nodes 104 of FIGS. 1 and 2 and the buyer devices 106, merchant systems 108, and dispute resolution systems 110 of FIG. 1 can be implemented in the computer system 500 using hardware, non-transitory computer readable media having instructions stored thereon, or a combination thereof and can be implemented in one or more computer systems or other processing systems. Hardware can embody modules and components used to implement the methods of FIGS. 3 and 4.

If programmable logic is used, such logic can execute on a commercially available processing platform configured by executable software code to become a specific purpose computer or a special purpose device (e.g., programmable logic array, application-specific integrated circuit, etc.). A person having ordinary skill in the art can appreciate that embodiments of the disclosed subject matter can be practiced with various computer system configurations, including multi-core multiprocessor systems, minicomputers, mainframe computers, computers linked or clustered with distributed functions, as well as pervasive or miniature computers that can be embedded into virtually any device. For instance, at least one processor device and a memory can be used to implement the above described embodiments.

A processor unit or device as discussed herein can be a single processor, a plurality of processors, or combinations thereof. Processor devices can have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations can be described as a sequential process, some of the operations can in fact be performed in parallel, concurrently, and/or in a distributed environment, and with program code stored locally or remotely for access by single or multi-processor machines. In addition, in some embodiments the order of operations can be rearranged without departing from the spirit of the disclosed subject matter.

Processor device 504 can be a special purpose or a general purpose processor device specifically configured to perform the functions discussed herein. The processor device 504 can be connected to a communications infrastructure 506, such as a bus, message queue, network, multi-core message-passing scheme, etc. The network can be any network suitable for performing the functions as disclosed herein and can include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 can also include a main memory 508 (e.g., random access memory, read-only memory, etc.), and can also include a secondary memory 510. The secondary memory 510 can include the hard disk drive 512 and a removable storage drive 514, such as a floppy disk drive, a magnetic tape drive, an optical disk drive, a flash memory, etc.

The removable storage drive 514 can read from and/or write to the removable storage unit 518 in a well-known manner. The removable storage unit 518 can include a removable storage media that can be read by and written to by the removable storage drive 514. For example, if the removable storage drive 514 is a floppy disk drive or universal serial bus port, the removable storage unit 518 can be a floppy disk or portable flash drive, respectively. In one embodiment, the removable storage unit 518 can be non-transitory computer readable recording media.

In some embodiments, the secondary memory 510 can include alternative means for allowing computer programs or other instructions to be loaded into the computer system 500, for example, the removable storage unit 522 and an interface 520. Examples of such means can include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) can be stored on any type of suitable computer readable media, such as optical storage (e.g., a compact disc, digital versatile disc, Blu-ray disc, etc.) or magnetic tape storage (e.g., a hard disk drive). The data can be configured in any type of suitable database configuration, such as a relational database, a structured query language (SQL) database, a distributed database, an object database, etc. Suitable configurations and storage types will be apparent to persons having skill in the relevant art.

The computer system 500 can also include a communications interface 524. The communications interface 524 can be configured to allow software and data to be transferred between the computer system 500 and external devices. Exemplary communications interfaces 524 can include a modem, a network interface (e.g., an Ethernet card), a communications port, a PCMCIA slot and card, etc. Software and data transferred via the communications interface 524 can be in the form of signals, which can be electronic, electromagnetic, optical, or other signals as will be apparent to persons having skill in the relevant art. The signals can travel via a communications path 526, which can be configured to carry the signals and can be implemented using wire, cable, fiber optics, a phone line, a cellular phone link, a radio frequency link, etc.

The computer system 500 can further include a display interface 502. The display interface 502 can be configured to allow data to be transferred between the computer system 500 and external display 530. Exemplary display interfaces 502 can include high-definition multimedia interface (HDMI), digital visual interface (DVI), video graphics array (VGA), etc. The display 530 can be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium can refer to memories, such as the main memory 508 and secondary memory 510, which can be memory semiconductors (e.g., DRAMs, etc.). These computer program products can be means for providing software to the computer system 500. Computer programs (e.g., computer control logic) can be stored in the main memory 508 and/or the secondary memory 510. Computer programs can also be received via the communications interface 524. Such computer programs, when executed, can enable computer system 500 to implement the present methods as discussed herein. In particular, the computer programs, when executed, can enable processor device 504 to implement the methods illustrated by FIGS. 3 and 4, as discussed herein. Accordingly, such computer programs can represent controllers of the computer system 500. Where the present disclosure is implemented using software, the software can be stored in a computer program product and loaded into the computer system 500 using the removable storage drive 514, interface 520, and hard disk drive 512, or communications interface 524.

The processor device 504 can comprise one or more modules or engines configured to perform the functions of the computer system 500. Each of the modules or engines can be implemented using hardware and, in some instances, can also utilize software, such as corresponding to program code and/or programs stored in the main memory 508 or secondary memory 510. In such instances, program code can be compiled by the processor device 504 (e.g., by a compiling module or engine) prior to execution by the hardware of the computer system 500. For example, the program code can be source code written in a programming language that is translated into a lower level language, such as assembly language or machine code, for execution by the processor device 504 and/or any additional hardware components of the computer system 500. The process of compiling can include the use of lexical analysis, preprocessing, parsing, semantic analysis, syntax-directed translation, code generation, code optimization, and any other techniques that can be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for facilitating dispute resolution for a blockchain transaction using a smart contract. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or can be acquired from practicing of the disclosure, without departing from the breadth or scope.

1. A method for facilitating dispute resolution for a blockchain transaction using a smart contract, comprising:
receiving, by a receiver of a blockchain node in a blockchain network, a smart contract from a merchant system, wherein the smart contract includes (i) data associated with three different blockchain wallets including data associated with a first blockchain wallet, data associated with a second blockchain wallet, data associated with a third blockchain wallet, and (ii) a period of time within which a buyer device is permitted to submit a dispute for an associated transaction;
receiving, by the receiver of the blockchain node, from the buyer device, a first blockchain transaction for payment of a digital currency amount from a fourth blockchain wallet associated with the buyer device to the first blockchain wallet, said first blockchain wallet being associated with said merchant system;
adding, by a processor of the blockchain node, the smart contract and the first blockchain transaction to a blockchain associated with the blockchain network in one or more first new blocks;
receiving, by the receiver of the blockchain node, a dispute notification from the buyer device, wherein the dispute notification identifies one of the first blockchain transaction and the smart contract;
determining, by the blockchain node, whether the dispute notification is received from the buyer device prior to expiration of the period of time included in the smart contract received from the merchant system;
in response to determining that the dispute notification is received from the buyer device prior to expiration of the period of time included in the smart contract received from the merchant system, adding, by the processor of the blockchain node, a dispute message to the blockchain;
generating and adding a second blockchain transaction to the blockchain in a second new block via self-execution of the smart contract upon detection of the dispute message, wherein the second blockchain transaction is for payment of the digital currency amount from the second blockchain wallet to the third blockchain wallet;
receiving, by the receiver of the blockchain node, a dispute resolution, wherein the dispute resolution indicates a decision for a first party or a second party; and
adding, by the processor of the blockchain node, a third blockchain transaction to the blockchain in a third new block, wherein the third blockchain transaction is for payment of the digital currency amount (i) from the third blockchain wallet to the fourth blockchain wallet if the dispute resolution indicates a decision for the first party, or (ii) from the third blockchain wallet to the first blockchain wallet if the dispute resolution indicates a decision for the second party.

2. The method of claim 1, wherein the third blockchain transaction is further for payment of an additional currency amount to a fifth blockchain wallet.

3. The method of claim 2, wherein
the fifth blockchain wallet is associated with a dispute resolution entity, and
the dispute resolution is received from the dispute resolution entity.

4. The method of claim 1, wherein
the smart contract further includes an identification value, and
the first blockchain transaction includes the identification value.

5. The method of claim 1, further comprising:
adding, by the processor of the blockchain node, the dispute resolution to the blockchain in a fourth new block prior to adding the third blockchain transaction to the blockchain.

6. The method of claim 5, wherein
the smart contract self-executes upon detection of the fourth new block including the dispute resolution, and
the receiver of the blockchain node receives, from self-execution of the smart contract, the third blockchain transaction.

7. The method of claim 1, further comprising:
adding, by the processor of the blockchain node, the dispute notification to the blockchain in a fourth new block prior to adding the second blockchain transaction to the blockchain.

8. (canceled)

9. A system for facilitating dispute resolution for a blockchain transaction using a smart contract, comprising:
a blockchain network including a plurality of blockchain nodes; and
a blockchain node included in the blockchain network, wherein
the blockchain node includes
a receiver
receiving a smart contract from a merchant system, wherein the smart contract includes (i) data associated with three different blockchain wallets including data associated with a first blockchain wallet, data associated with a second blockchain wallet, and data associated with a third blockchain wallet, and (ii) a period of time within which a buyer device is permitted to submit a dispute for an associated transaction, and
receiving, from the buyer device, a first blockchain transaction for payment of a digital currency amount from a fourth blockchain wallet associated with the buyer device to the first blockchain wallet, said first blockchain wallet being associated with said merchant system, and
a processor adding the smart contract and the first blockchain transaction to a blockchain associated with the blockchain network in one or more first new blocks,
the receiver of the blockchain node further receives, from the buyer device, a dispute notification, wherein the dispute notification identifies one of the first blockchain transaction and the smart contract,
the processor of the blockchain node further
determines whether the dispute notification is received from the buyer device prior to expiration of the period of time included in the smart contract received from the merchant system,
in response to determining that the dispute notification is received from the buyer device prior to expiration of the period of time included in the smart contract received from the merchant system, adds a dispute message to the blockchain, and
generates and adds a second blockchain transaction to the blockchain in a second new block via self-execution of the smart contract upon detection of the dispute message, wherein the second blockchain transaction is for payment of the digital currency amount from the second blockchain wallet to the third blockchain wallet,
the receiver of the blockchain node further receives a dispute resolution, wherein the dispute resolution indicates a decision for a first party or a second party, and
the processor of the blockchain node further adds a third blockchain transaction to the blockchain in a third new block, wherein the third blockchain transaction is for payment of the digital currency amount (i) from the third blockchain wallet to the fourth blockchain wallet if the dispute resolution indicates a decision for the first party, or (ii) from the third blockchain wallet to the first blockchain wallet if the dispute resolution indicates a decision for the second party.

10. The system of claim 9, wherein the third blockchain transaction is further for payment of an additional currency amount to a fifth blockchain wallet.

11. The system of claim 10, wherein
the fifth blockchain wallet is associated with a dispute resolution entity, and
the dispute resolution is received from the dispute resolution entity.

12. The system of claim 9, wherein
the smart contract further includes an identification value, and
the first blockchain transaction includes the identification value.

13. The system of claim 9, wherein the processor of the blockchain node further adds the dispute resolution to the blockchain in a fourth new block prior to adding the third blockchain transaction to the blockchain.

14. The system of claim 13, wherein
the smart contract self-executes upon detection of the fourth new block including the dispute resolution, and
the receiver of the blockchain node receives, from self-execution of the smart contract, the third blockchain transaction.

15. The system of claim 9, wherein the processor of the blockchain node further adds the dispute notification to the blockchain in a fourth new block prior to adding the second blockchain transaction to the blockchain.

16. (canceled)
